(19) United States
(12) Patent Application Publication
(10) Pub. No.: US 2025/0219255 A1
(43) Pub. Date: Jul. 3, 2025

(54) ENERGY STORAGE DEVICE

(71) Applicant: GS Yuasa International Ltd., Kyoto-shi (JP)

(72) Inventors: Yoshihito TAKAGI, Kyoto-shi (JP); Kazuya OKABE, Kyoto-shi (JP); Ryoichi OKUYAMA, Kyoto-shi (JP)

(21) Appl. No.: 19/079,547

(22) Filed: Mar. 14, 2025

Related U.S. Application Data
(63) Continuation of application No. PCT/JP2023/027086, filed on Jul. 25, 2023.

(30) Foreign Application Priority Data
Sep. 16, 2022 (JP) 2022-148545

(51) Int. Cl. H01M 50/491; H01M 10/0587; H01M 10/42; H01M 50/434; H01M 50/443; H01M 50/474; H01M 50/486; H01M 50/586; H01M 50/627

(52) U.S. Cl. CPC H01M 50/491; H01M 10/0587; H01M 10/4235; H01M 50/434; H01M 50/443; H01M 50/474; H01M 50/486; H01M 50/586; H01M 50/627

(57) ABSTRACT

An energy storage device includes an electrode body in which an electrode plate and a separator are stacked, an electrolyte solution, a container to accommodate the electrode body and the electrolyte solution, and a sheet-shaped porous body provided with an insulating property and between the electrode body and the container. A through hole is provided in the electrode plate.

### CROSS REFERENCE TO RELATED APPLICATIONS

This application claims the benefit of priority to Japanese Patent Application No. 2022-148545 filed on Sep. 16, 2022 and is a Continuation Application of PCT Application No. PCT/JP2023/027086 filed on Jul. 25, 2023. The entire contents of each application are hereby incorporated herein by reference.

### BACKGROUND OF THE INVENTION

### 1. Field of the Invention

The present invention relates to energy storage devices in each of which an electrode body and an electrolyte solution are accommodated in a container.

### 2. Description of the Related Art

Conventionally, an energy storage device including an electrode body in which an electrode plate and a separator are stacked, an electrolyte solution, and a container in which the electrode body and the electrolyte solution are accommodated, is widely known. For example, JP 2006-210031 A discloses a wound electrode body formed by stacking and winding a positive electrode plate and a negative electrode plate with a separator interposed therebetween, and a wound energy storage apparatus (energy storage device) in which an electrolyte solution is accommodated in a battery container.

### SUMMARY OF INVENTION

An energy storage device is desired to have a configuration in which an electrolyte solution can easily permeate an electrode body.

In the energy storage device disclosed in JP 2006-210031 A, a plurality of air passages are formed in the electrode body, and it is considered that an electrolyte solution easily permeates the electrode body via the air passages. However, in such an energy storage device, an insulating sheet is sometimes provided between the electrode body and the container in order to insulate the electrode body and the container from each other, in which case, there is a concern that the insulating sheet may block a path for the electrolyte solution during evacuation, liquid injection, or the like, during injection of the electrolyte solution into the container. As a result, the insulating sheet may inhibit permeation of the electrolyte solution into the electrode body, making it difficult for the electrolyte solution to permeate the electrode body.

Example embodiments of the present invention have been conceived of and developed by the inventors of the present invention by newly paying attention to the above problems, and example embodiments of the present invention provide energy storage devices in each of which an electrode body and a container are insulated from each other and an electrolyte solution can easily permeate the electrode body.

An energy storage device according to an example embodiment of the present invention includes an electrode body in which an electrode plate and a separator are stacked, an electrolyte solution, a container to accommodate the electrode body and the electrolyte solution, and a sheet-shaped porous body provided with an insulating property and between the electrode body and the container, wherein a through hole is provided in the electrode plate, and the porous body has lower air permeability than the separator.

According to the energy storage devices of example embodiments of the present invention, the electrolyte solution can easily permeate the electrode body while the electrode body and the container are insulated from each other.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an outer appearance of an energy storage device according to an example embodiment of the present invention.

FIG. 2 is an exploded perspective view illustrating disassembled elements of an energy storage device according to an example embodiment of the present invention.

FIG. 3 is a perspective view illustrating a configuration of an electrode body according to an example embodiment of the present invention.

FIGS. 4A and 4B are a perspective view and a sectional view illustrating the configuration of an electrode body according to an example embodiment of the present invention.

FIGS. 5A and 5B are a front view and a sectional view illustrating a configuration of a through hole of an electrode body according to an example embodiment of the present invention.

FIGS. 6A and 6B are a front view and a sectional view illustrating a configuration of a through hole of an electrode body according to a modification example 1 of an example embodiment of the present invention.

### DETAILED DESCRIPTION OF THE EXAMPLE EMBODIMENTS

(1) An energy storage device according to an example embodiment of the present invention includes an electrode body in which an electrode plate and a separator are stacked, an electrolyte solution, a container to accommodate the electrode body and the electrolyte solution, and a sheet-shaped porous body provided with an insulating property and between the electrode body and the container, wherein a through hole is provided in the electrode plate, and the porous body has lower air permeability than the separator.

According to an energy storage device according to an example embodiment of the present invention, in the energy storage device, a sheet-shaped structure having an insulating property (insulating sheet) is located between a container and an electrode body in which an electrode plate and a separator are stacked, a through hole is provided in the electrode plate, the insulating sheet is a porous body, and an air permeability of the porous body is lower than an air permeability of the separator. As described above, by providing the through hole in the electrode plate of the electrode body, the through hole can define and function as a path for the electrolyte solution, and therefore, the electrolyte solution easily permeates the electrode body. However, when the insulating sheet is provided between the electrode body and the container, the insulating sheet may block the path for the electrolyte solution to the electrode body during evacuation, liquid injection, or the like, when the electrolyte solution is injected into the container, which may make it difficult for the electrolyte solution to permeate the electrode body. This is why the insulating sheet is a porous body, and the porous body has lower air permeability than the separator. Accordingly, the electrolyte solution can pass through the porous body relatively easily, and thus the electrolyte solution easily permeates the electrode body. In this way, in the energy storage device, since the electrolyte solution can permeate the electrode body via the porous body and the through hole(s) of the electrode plate, the electrolyte solution can easily permeate the electrode body while insulating the electrode body and the container from each other.
(2) In the energy storage device according to the above (1), the porous body may have an air permeability of about 250 sec/100 mL or less, for example.

According to the energy storage device described in the above (2), by setting the air permeability of the porous body to be as low as about 250 sec/100 mL or less, for example, the electrolyte solution can pass through the porous body relatively easily.
(3) In the energy storage device according to the above (1) or (2), the porous body may be located between the container and the through hole.

When the porous body is located between the container and the through hole of the electrode body, the porous body may be brought into close contact with the through hole due to deformation of the container, or the like, during evacuation at the time of injection of an electrolyte solution into the container. According to the energy storage device described in the above (3), even in such a case, since the electrolyte solution can pass through the porous body by reducing the air permeability of the porous body, it is possible to prevent a path for the electrolyte solution to the electrode body from being blocked.
(4) In the energy storage device according to any one of the above (1) to (3), the electrode plate may include a positive electrode plate and a negative electrode plate, the positive electrode plate and the negative electrode plate may be respectively provided with a plurality of positive electrode through holes and a plurality of negative electrode through holes as the through holes, and the plurality of positive electrode through holes and the plurality of negative electrode through holes may overlap each other when viewed from a penetrating direction of the through holes.

According to the energy storage device described in the above (4), the plurality of positive electrode through holes and the plurality of negative electrode through holes are provided in the positive electrode plate and the negative electrode plate, and the plurality of positive electrode through holes and the plurality of negative electrode through holes overlap each other when viewed from the penetrating direction of the through holes. Accordingly, since the plurality of positive electrode through holes and the plurality of negative electrode through holes can define and function as paths for the electrolyte solution, the electrolyte solution more easily permeates the electrode body.
(5) In the energy storage device according to any one of the above (1) to (4), the electrode body may include the electrode plate with a wound configuration, and the container may include a liquid injector for the electrolyte solution, in a wall extending in a winding axis direction of the electrode body.

According to the energy storage device as stated in the above (5), the energy storage device has a configuration in which the electrode body with a wound structure, and the liquid injector for the electrolyte solution is provided in the wall of the container extending in the winding axis direction of the electrode body, and therefore, when the electrolyte solution is injected into the container, the electrolyte solution hardly permeates from the outside to the inside of the electrode body. In this way, the energy storage device has a structure in which the electrolyte solution hardly permeates the electrode body, and therefore, an advantageous effect obtained by adopting the configuration of an example embodiment of the present invention is high.
(6) In the energy storage device according to any one of the above (1) to (5), the porous body may include a nonwoven fabric.

According to the energy storage device as stated in the above (6), since the porous body includes a nonwoven fabric, the porous body can be thin, have high strength, and be inexpensive. Since it is sufficient to place the nonwoven fabric between the electrode body and the container, the porous body can be easily positioned.
(7) In the energy storage device according to any one of the above (1) to (6), the electrode body may include the electrode plate with a wound configuration, and the separator may include an inorganic coating layer including an inorganic particle.

According to the energy storage device described in the above (7) when an electrolyte solution is injected into a container of the energy storage device, in a wound electrode body, the electrolyte solution hardly permeates from the outside to the inside of the electrode body, and it is difficult to permeate the electrolyte solution into the electrode body. However, by coating the separator with the inorganic coating layer, the permeability of the electrolyte solution into the separator can be improved.
(8) In the energy storage device according to any one of the above (1) to (7), a length of the electrode body in a winding axis direction is about 500 mm or more, for example.

In the case of a wound electrode body having a length of about 500 mm or more in the winding axis direction, for example, it becomes even more difficult to permeate the electrolyte solution into the electrode body. However, according to the energy storage device as stated in the above (8), by coating the separator with the inorganic coating layer, the effect of improving the permeability of the electrolyte solution into the separator becomes remarkable. According to this example embodiment, since the time taken for the electrolyte solution to penetrate into the electrode body can be shortened, the electrolyte solution can easily penetrate into the electrode body.
(9) In the energy storage device according to any one of the above (1) to (8), a permeation area of the electrolyte solution in the inorganic coating layer at a 300-second mark after the electrolyte solution has been dropped may be about 80 mm² or more, for example.

According to the energy storage device described in the above (9), the inorganic coating layer included in the separator is an inorganic coating layer into which the electrolyte solution can permeate a relatively wide area in a relatively short time, such that a permeation area of the electrolyte solution at the 300-second mark after the electrolyte solution has been dropped is about 80 mm² or more, for example. In this way, because of the inorganic coating layer into which the electrolyte solution can permeate a relatively wide area in a relatively short time, the permeability of the electrolyte solution into the separator can be improved.
(10) In the energy storage device according to any one of the above (1) to (9), the inorganic coating layer may include at least one of barium sulfate or alumina as the inorganic particle.

The inventors of example embodiments of the present invention have discovered that when an electrolyte solution has been dropped onto an inorganic coating layer including at least one of barium sulfate or alumina, the electrolyte solution can permeate a relatively large area of the inorganic coating layer in a relatively short time. According to the energy storage device described in the above (10), at least one of barium sulfate and alumina is included in the inorganic coating layer of the separator, whereby permeability of an electrolyte solution into the separator can be improved.

Hereinafter, energy storage devices according to example embodiment(s) (including modification examples thereof) of the present invention will be described with reference to the drawings. Each of the example embodiment (s) to be described below illustrates a comprehensive or specific example. Numerical value(s), shape(s), material(s), element(s), feature(s), characteristic(s), alignment position(s) and coupling configuration(s) of the elements, manufacturing processes, order(s) of manufacturing processes, and the like, which will be described in the following example embodiments and modifications thereof, are merely examples, and are not intended to limit the present invention. In the drawings, dimensions, and the like, are not strictly illustrated. In the drawings, same or similar elements, portions, features, characteristics, etc., are assigned a same or similar reference numeral.

In the following description and drawings, an alignment direction of a pair of terminals (a positive electrode and a negative electrode, the same applies hereinafter) of an energy storage device, an alignment direction of a pair of current collectors, a winding axis direction of the electrode body, a direction in which the electrode body extends, or a direction in which a pair of short side surfaces of a container are opposed to each other, is defined as an X-axis direction. A direction in which long side surfaces of the container are opposed to each other or a thickness direction of the container is defined as a Y-axis direction. An alignment direction of a container main-body of the container and a lid of a container or an up-down direction is defined as a Z-axis direction. The X-axis direction, the Y-axis direction, and the Z-axis direction are directions intersecting each other (orthogonal to each other in the present example embodiment). Although there may be case where the Z-axis direction does not conform to the up-down direction depending on a use mode, the Z-axis direction will be described as the up-down direction in the following for convenience of description.

In the following description, for example, an X-axis positive direction indicates a direction of an arrow in the X-axis, and an X-axis negative direction indicates a direction opposite to the X-axis positive direction. When simply referred to as the X-axis direction, it indicates both or one of the X-axis positive direction and the X-axis negative direction. When referred to as one side and the other side of the X-axis direction, it indicates one and the other of the X-axis positive direction and the X-axis negative direction. The same applies to the Y-axis direction and the Z-axis direction. Expressions indicating relative directions or postures, such as parallel and orthogonal, include cases where the directions or postures are not parallel or orthogonal in a strict sense. Two directions being parallel to each other means not only that the two directions are completely parallel to each other, but also that the two directions are substantially parallel to each other, in other words, a difference by several percent or so, for example, is included in the scope. In the following description, when the expression “insulation” is used, “insulation” is intended to mean “electrical insulation”.

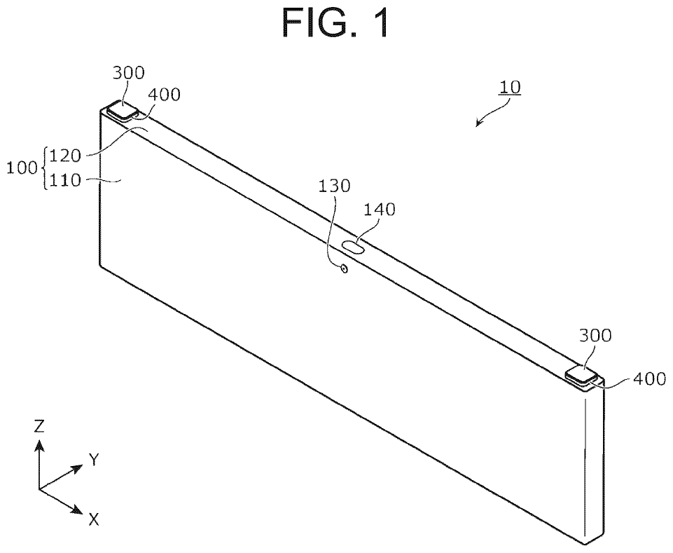

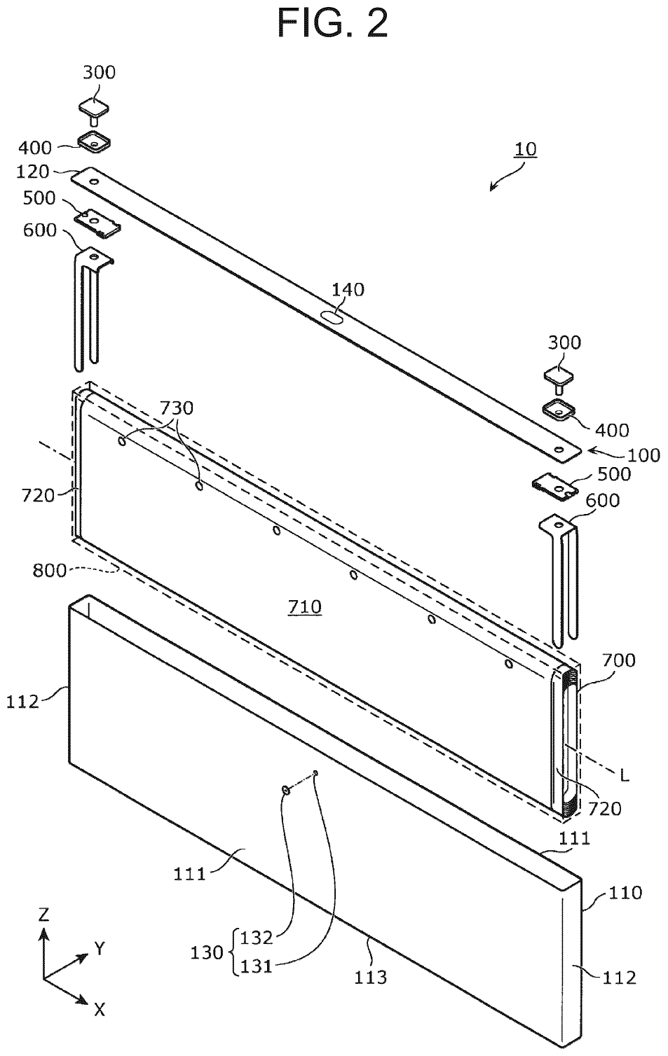

First, a general description of an energy storage device 10 according to the present example embodiment will be given with reference to FIG. 1 and FIG. 2. FIG. 1 is a perspective view illustrating an outer appearance of the energy storage device 10 according to the present example embodiment. FIG. 2 is an exploded perspective view illustrating respective elements by disassembling the energy storage device 10 according to the present example embodiment. In FIG. 2, the porous body 800 is indicated by a broken line, and a configuration of the electrode body 700 is illustrated by seeing through the porous body 800.

The energy storage device 10 is a secondary battery (a single battery) capable of charging electricity and discharging electricity, and more specifically, is a non-aqueous electrolyte secondary battery such as a lithium-ion secondary battery. Specifically, the energy storage device 10 is used as a battery to drive or start an engine of a movable body such as an automobile, a motorcycle, a watercraft, a vessel, a snowmobile, an agricultural machine, a construction machine, or a railway vehicle for electric railway. As the above-mentioned automobile, an electric vehicle (EV), a hybrid electric vehicle (HEV), a plug-in hybrid electric vehicle (PHEV), and a fossil fuel (gasoline, light oil, liquefied natural gas, or the like) automobile are exemplified. As the above-mentioned railway vehicle for electric railway, a train, a monorail, a magnetic levitation train, and a hybrid train provided with both a diesel engine and an electric motor are exemplified. The energy storage device 10 can also be used as a stationary battery, or the like, that is used for home, business, or the like.

The energy storage device 10 is not limited to the non-aqueous electrolyte secondary battery, and may be a secondary battery other than the non-aqueous electrolyte secondary battery, or may be a capacitor. The energy storage device 10 does not necessarily have to be a secondary battery, and may be a primary battery capable of using electricity that is stored even without being charged by a user. The energy storage device 10 may be a pouch-type energy storage device. In the present example embodiment, the energy storage device 10 having a rectangular parallelepiped shape (rectangular shape) that is flat in the Y-axis direction is illustrated, however, the shape of the energy storage device 10 is not limited to the rectangular parallelepiped shape, and may be a polygonal columnar shape other than a rectangular parallelepiped shape, an elongated cylindrical shape, an elliptical cylindrical shape, a cylindrical shape, or the like.

As illustrated in FIG. 1, the energy storage device 10 includes a container 100, a pair of (positive electrode and negative electrode) terminals 300, and a pair of (positive electrode and negative electrode) upper gaskets 400. As illustrated in FIG. 2, a pair of (positive electrode and negative electrode) lower gaskets 500, a pair of (positive electrode and negative electrode) current collectors 600, an electrode body 700, and a porous body 800 are accommodated inside the container 100. In addition to the above-described elements, a spacer, or the like, may be provided on a side of or below the electrode body 700 or the porous body 800.

An electrolyte solution (non-aqueous electrolyte) is sealed inside the container 100, however, illustration thereof is omitted. The type of the electrolyte solution is not particularly limited as long as the performance of the energy storage device 10 is not impaired, and various electrolyte solutions can be selected. The electrolyte solution includes a non-aqueous solvent and an electrolyte salt dissolved in the non-aqueous solvent.

The non-aqueous solvent can be appropriately selected from known non-aqueous solvents. Examples of the non-aqueous solvent include cyclic carbonates such as ethylene carbonate (EC) and propylene carbonate (PC), chain carbonates such as ethyl methyl carbonate (EMC), carboxylic acid esters, phosphoric acid esters, sulfonic acid esters, ethers, amides, and nitriles. As the non-aqueous solvent, those obtained by substituting a portion of hydrogen atoms included in these compounds with halogen may be used. The electrolyte salt can be appropriately selected from known electrolyte salts. Examples of the electrolyte salt include a lithium salt such as an inorganic lithium salt of LiPF₆, or the like, a sodium salt, a potassium salt, a magnesium salt, an onium salt, and the like. Among these, a lithium salt is preferable. The electrolyte solution may include an additive such as biphenyl, in addition to the non-aqueous solvent and the electrolyte salt.

The container 100 is a case having a rectangular parallelepiped shape (a rectangular shape or a box shape), the case including a container main-body 110 in which an opening is located on the Z-axis positive direction side, and a lid 120 that closes the opening of the container main-body 110. The lid 120 is a flat plate-shaped and rectangular structure defining a lid portion of the container 100, and is provided in the Z-axis positive direction of the container main-body 110. The lid 120 is a wall extending in the winding axis direction of the electrode body 700.

The winding axis direction of the electrode body 700 is a direction in which a winding axis L of the electrode body 700 to be described later extends (a direction along the winding axis L, which is the X-axis direction in the present example embodiment).

The container main-body 110 has a rectangular cylindrical shape and includes a bottom, which defines a main-body portion of the container 100. The container main-body 110 includes a pair of long side walls 111 on surfaces (side surfaces) on both sides in the Y-axis direction, a pair of short side walls 112 on surfaces (side surfaces) on both sides in the X-axis direction, and a bottom wall 113 on a surface (bottom surface) in the Z-axis negative direction. The long side walls 111 are flat plate-shaped and rectangular walls extending in the X-axis direction (the winding axis direction of the electrode body 700), and define long side surfaces of the container 100. The long side wall 111 is adjacent to the short side wall 112, the bottom wall 113, and the lid 120, and is larger in area than the short side wall 112. The short side walls 112 are flat plate-shaped and rectangular walls extending in the Z-axis direction, and define short side surfaces of the container 100. The short side walls 112 are adjacent to the long side walls 111, the bottom wall 113, and the lid 120, and are smaller in area than the long side walls 111. The bottom wall 113 is a flat plate-shaped and rectangular wall extending in the X-axis direction (the winding axis direction of the electrode body 700), and defines a bottom surface of the container 100. The bottom wall 113 is adjacent to the long side walls 111 and the short side walls 112.

The container 100 has a configuration in which the interior of the container 100 is sealed (tightly sealed), by accommodating the electrode body 700, the porous body 800, and the like, inside the container main-body 110, and thereafter having the container main-body 110 and the lid 120 joined to each other by welding, or the like. The material of the container 100 (the container main-body 110 and the lid 120) is not particularly limited, and can be, for example, a weldable (joinable) metal, such as stainless steel, aluminum, aluminum alloy, iron, or a plated steel plate, however, a resin can also be used. The container main-body 110 and the lid 120 may be made of a same material, or may be made of different materials. When the energy storage device 10 is a pouch-type energy storage device, the container 100 may be a laminated film including a plurality of layers including a metal layer and a resin layer.

A liquid injector 130 and a gas discharge valve 140 are provided in the container 100. In the present example embodiment, the liquid injector 130 is provided in the long side wall 111 of the container main-body 110, and the gas discharge valve 140 is provided in the lid 120. That is, the liquid injector 130 and the gas discharge valve 140 are provided in walls (different walls in the present example embodiment) extending in the winding axis direction (X-axis direction) of the electrode body 700. The gas discharge valve 140 is a safety valve to release a pressure inside the container 100 when the pressure rises excessively. In the present example embodiment, the gas discharge valve 140 is located at a central portion of the lid 120 in the X-axis direction and a central portion of the lid 120 in the Y-axis direction, however, may be located at any position of the lid 120.

The liquid injector 130 is configured to inject an electrolyte solution into the container 100 during manufacture of the energy storage device 10 (i.e., a liquid injector for an electrolyte solution). The liquid injector 130 is used to evacuate the inside of the container 100, inject an electrolyte solution into the container 100 to impregnate the electrode body 700 with the electrolyte solution, or remove gas from the inside of the electrode body 700, at the time of manufacturing the energy storage device 10. In the present example embodiment, the liquid injector 130 is located at an end of the long side wall 111 in the Y-axis negative direction of the container main-body 110, in the Z-axis positive direction and at a central portion thereof in the X-axis direction.

The liquid injector 130 includes a liquid injection port 131 and a liquid injection plug 132. The liquid injection port 131 includes a through hole provided in the container 100 to inject an electrolyte solution into the container 100. In the present example embodiment, the liquid injection port 131 is, for example, a circular through hole located at an end in the Z-axis positive direction of an elongated side wall 111 in the Y-axis negative direction of the container main-body 110 of the container 100 and at a central portion thereof in the X-axis direction. The liquid injection plug 132 is configured to close the liquid injection port 131. Specifically, the liquid injection plug 132 is a closure (lid) which is joined to the long side wall 111 to close the liquid injection port 131 after the inside of the container 100 is evacuated from the liquid injection port 131 to inject an electrolyte solution into the container 100 during manufacture of the energy storage device 10. A material of the liquid injection plug 132 is not particularly limited, however, any metal, or the like, which can be used for the container 100 (container main-body 110) can be used. In particular, the liquid injection plug 132 is preferably made of a material weldable to the container main-body 110, such as the same material as that of the container main-body 110.

The terminals 300 are terminals (a positive electrode terminal and a negative electrode terminal) to be electrically coupled to the electrode body 700 via the current collector 600. Namely, the terminal 300 is a metal structure to lead out electricity stored in the electrode body 700 to an outer space of the energy storage device 10 and to introduce electricity into the internal space of the energy storage device 10 in order to store the electricity in the electrode body 700. The terminal 300 includes a conductive structure made of metal, or the like, such as aluminum, an aluminum alloy, copper, or a copper alloy. The terminal 300 is coupled (joined) to the current collector 600 by caulking joining, welding, or the like, and is attached to the lid 120. The terminal 300 protrudes in the Z-axis positive direction from an outer surface (a surface in the Z-axis positive direction) of the lid 120.

In the present example embodiment, the terminal 300 is a welded terminal to be joined to a conductor, such as an external bus bar, by welding. However, the terminal 300 may be a bolt terminal which includes a bolt portion in which a male screw portion protruding in the Z-axis positive direction is provided, and is to be joined to the conductor by bolt coupling.

The current collectors 600 are conductive current collectors (a positive electrode current collector and a negative electrode current collector) that are provided on both sides of the electrode body 700 in the X-axis direction, are coupled (joined) to the electrode body 700 and the terminals 300, and electrically connect the electrode body 700 and the terminal 300. The current collectors 600 are coupled (joined) to ends 720 of the electrode body 700, which will be described later, by welding, caulking joining, or the like, and are coupled (joined) to the terminals 300 by caulking joining, welding, or the like, as described above, to be fixed to the lid 120. The material of the current collector 600 is not particularly limited. However, in the present example embodiment, the current collector 600 of the positive electrode is made of aluminum, an aluminum alloy, or the like, similarly to a positive electrode current collector foil 741 of the electrode body 700 to be described later, and the current collector 600 of the negative electrode is made of copper, a copper alloy, or the like, similarly to a negative electrode current collector foil 751 of the electrode body 700 to be described later.

The upper gasket 400 is a plate-shaped and rectangular gasket which is located between the lid 120 of the container 100 and the terminal 300, and insulates and seals between the lid 120 and the terminal 300. The lower gasket 500 is a plate-shaped and rectangular gasket which is located between the lid 120 and the current collector 600 and insulates between the lid 120 and the current collector 600. The upper gasket 400 and the lower gasket 500 are made of an insulator, or the like, such as polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), ABS resin, or a composite material thereof.

The electrode body 700 is an energy storage component (power generation component) capable of storing electricity, which is constructed by stacking electrode plates (a positive electrode plate 740 and a negative electrode plate 750 to be described later) and a separator (a separator 760 to be described later). In the present example embodiment, the electrode body 700 is constructed by winding an electrode plate and a separator. The electrode body 700 has an elongated shape extending in the X-axis direction, and has an oval shape (long cylindrical shape) as viewed in the X-axis direction. The electrode body 700 includes the electrode body main-body portion 710 and the ends 720 protruding to both sides in the X-axis direction from the electrode body main-body portion 710, and as described above, the ends 720 are coupled (joined) to the current collector 600. A through hole 730 is provided in the electrode body main-body portion 710. A configuration of the electrode body 700 will be described in detail below.

The porous body 800 is a sheet-shaped body (an insulating sheet or an insulating film) having an insulating property, which is located between the electrode body 700 and the container 100. The porous body 800 wraps the electrode body 700 and the current collector 600 to secure insulation between the container 100, and the electrode body 700 and the current collector 600. In order to secure an insulating property, the porous body 800 preferably has a resistance of about 1MΩ or more when about 100V is applied, for example. In the present example embodiment, the porous body 800 is a bottomed rectangular cylindrical insulating sheet configured to cover both sides of the electrode body 700 and the current collector 600 in the X-axis direction, both sides thereof in the Y-axis direction, and the Z-axis negative direction thereof. That is, the porous body 800 is located between the pair of long side walls 111, the pair of short side walls 112, and the bottom wall 113 of the container 100, and the electrode body 700 and the current collector 600, thus ensuring insulation between the container 100, and the electrode body 700 and the current collector 600.

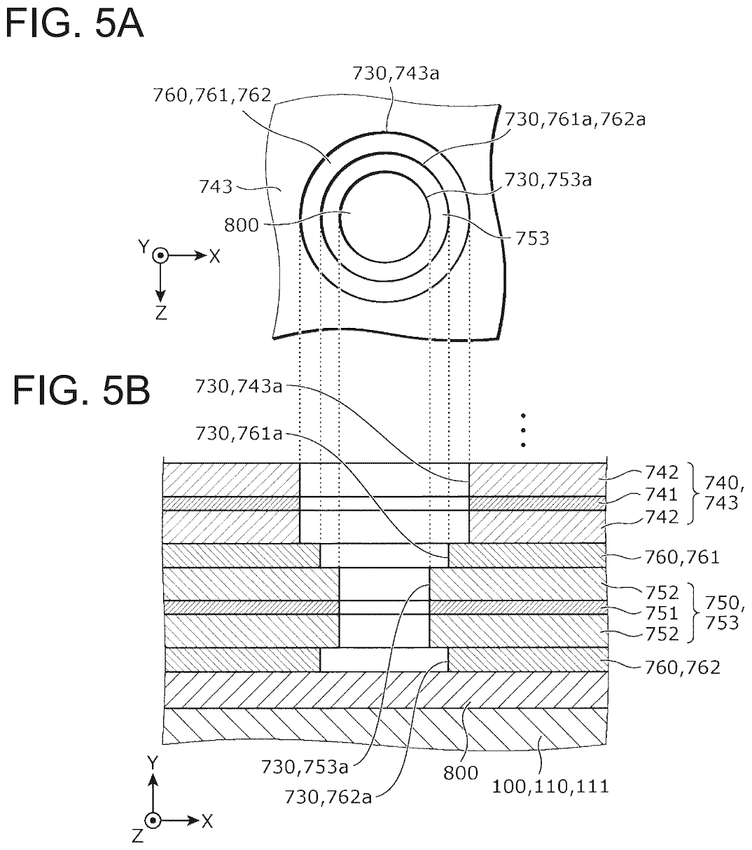

The porous body 800 is in contact with the container 100 (the long side walls 111) and the electrode body 700, on both sides of the electrode body 700 in the Y-axis direction (refer to FIGS. 5A and 5B). The porous body 800 is located between the container 100 (the long side wall 111) and the through hole 730 in the Y-axis negative direction of the electrode body 700 (refer to FIGS. 5A and 5B). The porous body 800 is preferably located at least between a portion of the periphery of the through hole 730 and the container 100, however, in the present example embodiment, is located between the through hole 730 and the entire periphery of the through hole 730 and the container 100, so as to cover the entire through hole 730. Specifically, the porous body 800 is in contact with the entire circumference of the through hole 730 and the long side wall 111 of the container 100. Furthermore, the porous body 800 is located between the liquid injector 130 provided in the long side wall 111 and the electrode body 700. Specifically, the porous body 800 is in contact with the entire circumference of the liquid injection port 131 provided in the long side wall 111 and the electrode body 700.

In this way, the porous body 800 is provided between the liquid injector 130 and the through hole 730 (i.e., in a path for the electrolyte solution from the liquid injector 130 to the through hole 730).

On both sides of the electrode body 700 in the X-axis direction, the porous body 800 is located in the vicinity of the short side walls 112 of the container 100 or in contact with the short side walls 112. The porous body 800 is located in the vicinity of the bottom wall 113 of the container 100 or in contact with the bottom wall 113, in the Z-axis negative direction of the electrode body 700. As a result, the porous body 800 absorbs excess electrolyte solution accumulated in the lower portion of the container 100. The porous body 800 may be in contact with the electrode body 700 (or the current collector 600), or may be separated from the electrode body 700 (or the current collector 600), on both sides of the electrode body 700 in the X-axis direction and in the Z-axis negative direction thereof.

The porous body 800 and a separator 760 (described later), which is included in the electrode body 700, are separate structural elements from each other. The porous body 800 may have lower air permeability than the separator 760. The porous body 800 may have larger pores (for example, about 100 μm or more) than those of the separator 760. The air permeability is also referred to as a Gurley value, indicates the number of seconds for a certain volume of air to pass through an object having a certain area under a certain pressure difference, and is a value measured in accordance with JIS-P8117 (2009). In general, the air permeability of the separators 760 is about 540 sec/100 mL when the separators 760 are about 30 μm thick, about 270 sec/100 mL when the separators 760 are about 20 μm thick, and about 300 sec/100 mL when the separators 760 are about 20 μm thick and are ceramic-coated, for example. Therefore, the porous body 800 preferably has air permeability of about 250 sec/100 mL or less, for example. In the present example embodiment, the air permeability of the separators 760 is about 300 sec/100 mL, for example.

The porous body 800 includes a nonwoven fabric. In the present example embodiment, the porous body 800 is a porous body of a polyolefin such as PP (polypropylene), and specifically, includes polymer nonwoven fabric made of PP. The air permeability of the PP nonwoven fabric is about 10 sec/100 mL to about 100 sec/100 mL, for example. Therefore, the porous body 800 more preferably has air permeability of about 100 sec/100 mL or less, for example. The porous body 800 may include other nonwoven fabric such as a glass fiber nonwoven fabric, may include a foam body (a PP foam sheet or the like), or may include an elastic body or the like. The air permeability of the glass fiber nonwoven fabric (glass fiber paper of about 100 μm) is about 4 sec/100 mL, for example. The air permeability of the PP foam sheet (continuous pores) is about 10 sec/100 mL to about 20 sec/100 mL, for example. Therefore, the porous body 800 more preferably has air permeability of about 20 sec/100 mL or less, for example.

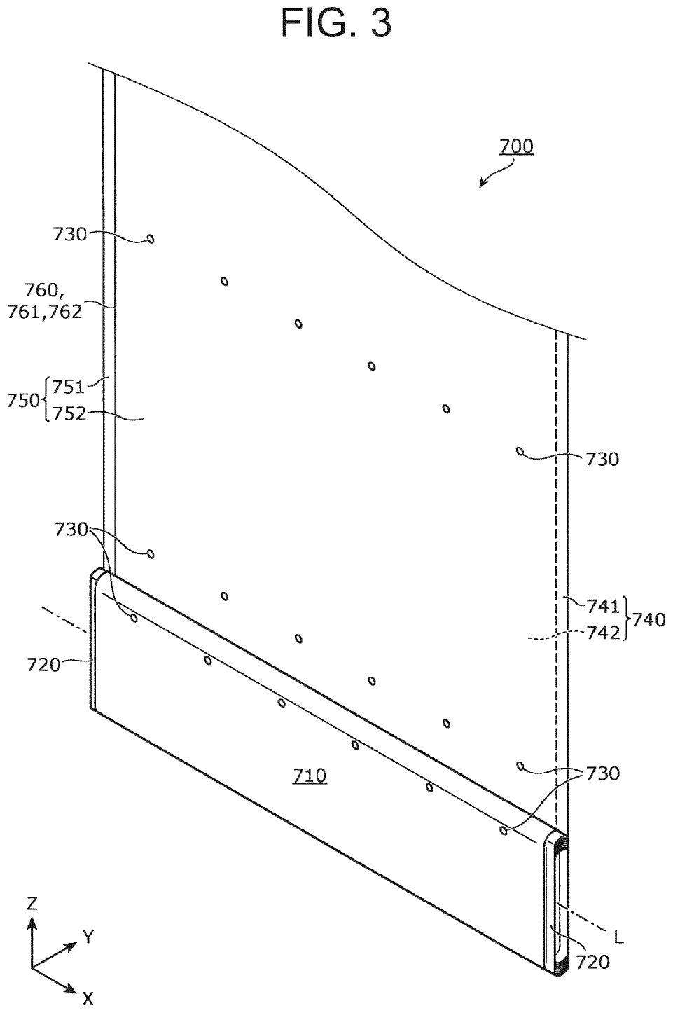

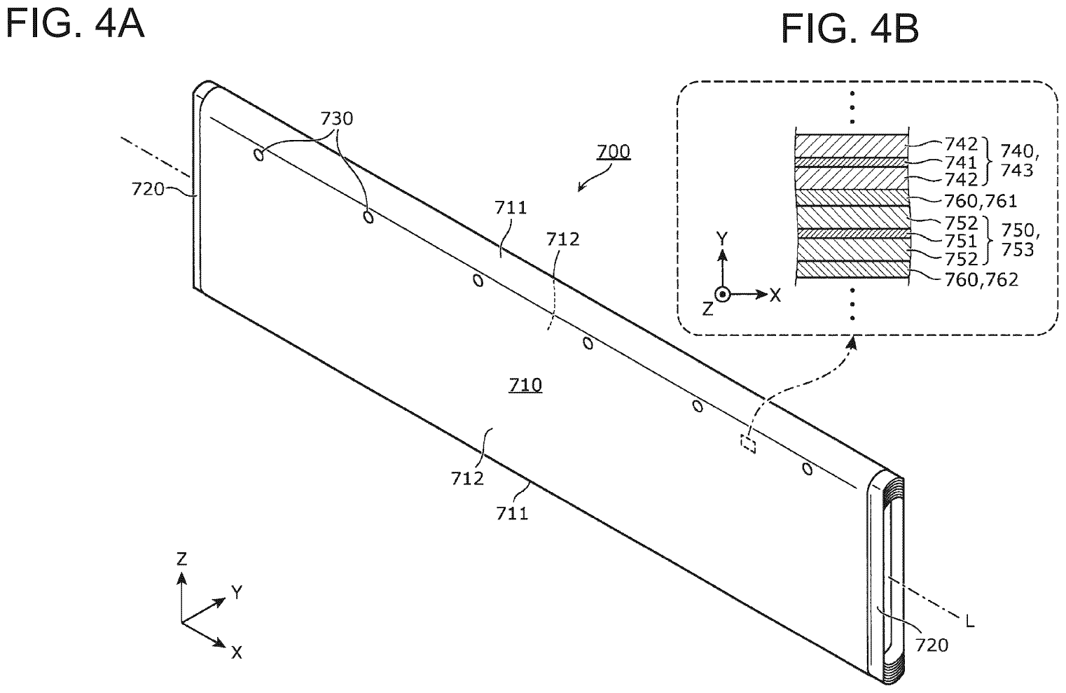

Next, a configuration of the electrode body 700 will be described in detail. FIG. 3 is a perspective view illustrating a configuration of the electrode body 700 according to the present example embodiment. FIG. 3 illustrates a configuration of the electrode body 700 in a state in which a wound state of an electrode plate is partially unwound. FIGS. 4A and 4B are a perspective view and a sectional view illustrating a configuration of the electrode body 700 according to the present example embodiment.

FIG. 4A is a perspective view illustrating a configuration of the electrode body 700 after the electrode plate is wound, and FIG. 4B is a sectional view illustrating a state in which the electrode plates are stacked, by enlarging a cross section of a portion of the electrode body 700.

As illustrated in FIG. 3 and FIGS. 4A and 4B, the electrode body 700 includes, as electrode plates, a positive electrode plate 740 and a negative electrode plate 750 which are two electrode plates, and includes, as separators, separators 761 and 762 which are two separators 760.

The positive electrode plate 740 is an electrode plate in which a positive electrode active material layer 742 is located on a surface of a positive electrode current collector foil 741 which is an elongated band-shaped current collector foil (metal foil) made of metal such as aluminum or an aluminum alloy. The negative electrode plate 750 is an electrode plate in which a negative electrode active material layer 752 is located on a surface of a negative electrode current collector foil 751 which is an elongated band-shaped current collector foil (metal foil) made of metal such as copper or a copper alloy. As the positive electrode current collector foil 741 and the negative electrode current collector foil 751, a known material can be appropriately used as long as it is a material stable to an oxidation-reduction reaction during charge and discharge, such as nickel, iron, stainless steel, titanium, fired carbon, a conductive polymer, conductive glass, or an Al—Cd alloy. As a positive electrode active material used for the positive electrode active material layer 742 and a negative electrode active material used for the negative electrode active material layer 752, known materials can be appropriately used as long as they are a positive electrode active material and a negative electrode active material capable of storing and releasing lithium ions.

Examples of the positive electrode active material include polyanion compounds such as LiMPO₄, LiMSiO₄, and LiMBO₃ (M is one or more transition metal devices selected from Fe, Ni, Mn, Co, and the like), lithium titanate, spinel-type lithium-manganese oxides such as LiMn₂O₄, LiMn_{1.5}Ni_{0.5}O₄, lithium-transition metal oxides such as LiMO₂ (M is one or more transition metal devices selected from Fe, Ni, Mn, Co, and the like), and the like. Examples of the negative electrode active material include lithium metals, lithium alloys (lithium-metal-including alloys such as lithium-silicon, lithium-aluminum, lithium-lead, lithium-tin, lithium-aluminum-tin, lithium-gallium, and Wood's alloy), alloys capable of storing and releasing lithium, carbonaceous materials (e.g., graphite, non-graphitizable carbons, graphitizable carbons, low-temperature fired carbons, and amorphous carbons), silicon oxides, metallic oxides, lithium-metallic oxides (e.g., Li₄Ti₅O₁₂), polyphosphate compounds, and compounds of transition metals and Group 14 to Group 16 devices, such as Co₃O₄ and Fe₂P, which are generally referred to as conversion negative electrodes.

The separator 760 (the separators 761 and 762) is a microporous insulating sheet made of resin, or the like. As a material of the separator 760, a known material can be appropriately used as long as the performance of the energy storage device 10 is not impaired. The separator 760 may include a woven fabric, a nonwoven fabric, or a porous resin film, for example. Among these shapes, a porous resin film is preferable from the viewpoint of strength, and a nonwoven fabric is preferable from the viewpoint of liquid retainability of the electrolyte solution. As a material of the separator 760, polyolefin such as polyethylene or polypropylene is preferable from the viewpoint of a shutdown function, and polyimide, aramid, or the like, is preferable from the viewpoint of oxidation and decomposition resistance. A composite material of these resins may be used as the separator 760. The separators 761 and 762 may be made of a same material, or may be made of different materials.

The electrode body 700 may be formed by alternately stacking and winding the positive electrode plate 740 and the negative electrode plate 750 having the above-described configurations, and the separators 761 and 762, for example. That is, the electrode body 700 may be formed by stacking and winding the positive electrode plate 740, the separator 761, the negative electrode plate 750, and the separator 762 in this order (refer to FIG. 4B and the like). In the present example embodiment, the electrode body 700 is a winding electrode body formed by winding a positive electrode plate 740, a negative electrode plate 750, and the like, around a winding axis L extending in the X-axis direction. The winding axis L is a virtual axis serving as a central axis when the positive electrode plate 740, the negative electrode plate 750, and the like, are wound, and is a straight line passing through the center of the electrode body 700 and parallel to the X-axis direction in the present example embodiment.

Specifically, in the electrode body 700, the positive electrode plate 740 and the negative electrode plate 750 are wound with the separators 761 and 762 interposed therebetween, while being shifted from each other in a direction along the winding axis L (a winding axis direction, i.e., the X-axis direction in the present example embodiment). The positive electrode plate 740 and the negative electrode plate 750 each have, at an end in the shifted direction, a portion (active material layer non-forming portion) in which the positive electrode current collector foil 741 and the negative electrode current collector foil 751 are exposed without being provided (coated) with the positive electrode active material layer 742 and the negative electrode active material layer 752. Accordingly, the electrode body 700 includes, at one end in the winding axis direction, an end 720 of the positive electrode in which the active material layer non-forming portions of the positive electrode plates 740 are stacked and bundled, and includes, at the other end in the winding axis direction, an end 720 of the negative electrode in which the active material layer non-forming portions of the negative electrode plates 750 are stacked and bundled.

In the end 720, the positive electrode plate 740 or the negative electrode plate 750 is stacked in the stacking direction (Y-axis direction). That is, the electrode body 700 includes an electrode body main-body portion 710 defining a main body of the electrode body 700, and a pair of (positive and negative) ends 720 protruding from the electrode body main-body portion 710 to both sides in the X-axis direction. The electrode body main-body portion 710 is a portion (active material layer forming portion) having an elongated cylindrical shape, which is formed by winding portions of the positive electrode plate 740 and the negative electrode plate 750, on which the positive electrode active material layer 742 and the negative electrode active material layer 752 are formed (coated), and the separators 761 and 762. Accordingly, the electrode body main-body portion 710 includes a pair of curved portions 711 on both sides in the Z-axis direction, and includes a pair of flat portions 712 on both sides in the Y-axis direction (refer to FIG. 4A). That is, the electrode body 700 includes a curved portion 711 having a curved shape and a flat portion 712 having a flat shape, which are formed by winding the positive electrode plate 740 and the negative electrode plate 750 around the winding axis L.

The curved portion 711 is a curved portion which is curved in a semicircular arc shape to protrude in the Z-axis direction when viewed in the X-axis direction and extends in the X-axis direction, and is opposed to the bottom wall 113 of the container main-body 110 and the lid 120. That is, the pair of curved portions 711 are portions curved to protrude to both sides in the Z-axis direction toward the bottom wall 113 of the container main-body 110 and the lid 120 when viewed in the X-axis direction. The flat portion 712 is a rectangular and flat portion which couples ends of the pair of curved portions 711 and extends parallel to an XZ plane facing in the Y-axis direction, and is opposed to the long side walls 111 on both sides of the container main-body 110 in the Y-axis direction. The curved shape of the curved portion 711 is not limited to a semicircular arc shape, and may be a portion of an elliptical shape, or the like, or may be curved in any manner. The outer surface of the flat portion 712 facing in the Y-axis direction is not limited to being a plane, and the outer surface may be slightly recessed or slightly expanded.

According to the above-described configuration, the electrode body 700 has an elongated (horizontally long) shape whose length in the winding axis direction (X-axis direction) is elongated. In the present example embodiment, the electrode body 700 has a shape in which a length in the X-axis direction is about 300 mm or more, and to be specific, is about 500 mm to about 1500 mm long extending in the X-axis direction, for example. The length of the electrode body 700 in the X-axis direction is not particularly limited, and may be shorter than the about 300 mm or may be longer than the about 1500 mm, for example. Furthermore, one or more through holes 730 are provided in the electrode body 700. That is, one or more through holes 730 are provided in the electrode plates (the positive electrode plate 740 and the negative electrode plate 750) of the electrode body 700. In the present example embodiment, a plurality of (e.g., six) through holes 730 are provided in the electrode body main-body portion 710 of the electrode body 700. The configuration of the through hole 730 will be described in detail below with reference to FIGS. 5A and 5B as well.

FIGS. 5A and 5B are a front view and a sectional view illustrating a configuration of the through hole 730 of the electrode body 700 according to the present example embodiment. FIG. 5A is a front view illustrating a configuration of the through hole 730 of the electrode body 700 when viewed from the front (Y-axis positive direction), and FIG. 5B is a sectional view illustrating a cross section of FIG. 5A. In FIGS. 5A and 5B, the porous body 800 and the long side walls 111 are also illustrated in order to illustrate a positional relationship between the electrode body 700 (the through hole 730), and the porous body 800 and the long side walls 111 of the container main-body 110 of the container 100. Since the plurality of (e.g., six) through holes 730 provided in the electrode body 700 have the same configuration, one through hole 730 is illustrated in FIGS. 5A and 5B, and the one through hole 730 will be described in detail.

As illustrated in FIG. 2 to FIGS. 4A and 4B, the through hole 730 is located in a central portion in the X-axis direction and an end in the Z-axis positive direction of the flat portion 712 of the electrode body main-body portion 710 in the Y-axis negative direction. That is, the through hole 730 is opposed to the long side wall 111 in the Y-axis negative direction of the container main-body 110 of the container 100, and is close to the liquid injector 130. In the present example embodiment, in the electrode body main-body portion 710, six through holes 730, for example, are aligned at predetermined intervals in the winding axis direction (X-axis direction). A distance between two adjacent through holes 730 or a distance between an edge of the electrode body 700 in the winding axis direction (X-axis direction) and a through hole 730 closest to the edge is, for example, greater than or equal to about 100 mm and less than or equal to about 300 mm. For example, when the length of the electrode body 700 in the X-axis direction is about 1400 mm, the six through holes 730 are positioned at intervals of about 200 mm.

As illustrated in FIG. 4B and FIGS. 5A and 5B, a portion of the positive electrode plate 740 in which the positive electrode active material layer 742 is formed (coated) on the positive electrode current collector foil 741 is referred to as a positive electrode active material portion 743. A portion of the negative electrode plate 750 in which the negative electrode active material layer 752 is formed (coated) on the negative electrode current collector foil 751 is referred to as a negative electrode active material portion 753. That is, the positive electrode current collector foil 741 and the positive electrode active material layer 742 excluding a portion included in the end 720 of the positive electrode are referred to as a positive electrode active material portion 743, and the negative electrode current collector foil 751 and the negative electrode active material layer 752 excluding a portion included in the end 720 of the negative electrode are referred to as a negative electrode active material portion 753. In other words, a portion of the positive electrode plate 740 other than the positive electrode current collector foil 741 included in the end 720 of the positive electrode is referred to as a positive electrode active material portion 743, and a portion of the negative electrode plate 750 other than the negative electrode current collector foil 751 included in the end 720 of the negative electrode is referred to as a negative electrode active material portion 753.

Specifically, in FIG. 4B and FIGS. 5A and 5B, of the positive electrode plate 740 in the electrode body 700, three layers in which the positive electrode active material layers 742 (two layers) are provided on both surfaces of the positive electrode current collector foil 741 (one layer) are referred to as one positive electrode active material portion 743 as one unit. Of the negative electrode plate 750 in the electrode body 700, three layers in which the negative electrode active material layers 752 (two layers) are provided on both surfaces of the negative electrode current collector foil 751 (one layer) are referred to as one negative electrode active material portion 753 as one unit. That is, the positive electrode plate 740 and the negative electrode plate 750 are wound, such that the plurality of positive electrode active material portions 743 and the plurality of negative electrode active material portions 753 are stacked in a state where the separators 761 and 762 are between the positive electrode active material portions 743 and the negative electrode active material portions 753. The electrode body main-body portion 710 is formed by stacking the plurality of positive electrode active material portions 743, the plurality of negative electrode active material portions 753, and the separators 761 and 762.

A through hole 730 is provided in at least one of the positive electrode active material portion 743 or the negative electrode active material portion 753 which are positioned in the flat portion 712 of the electrode body main-body portion 710.

In the present example embodiment, the through holes 730 are provided in both the positive electrode active material portion 743 and the negative electrode active material portion 753, and in the separators 761 and 762.

To be specific, as illustrated in FIGS. 5A and 5B, a positive electrode through hole 743a serving as the through hole 730 is provided in the positive electrode active material portion 743. The positive electrode through hole 743a is a circular through hole penetrating the positive electrode active material portion 743 in the Y-axis direction. That is, the positive electrode through hole 743a is a circular through hole penetrating, in the Y-axis direction, the positive electrode current collector foil 741 and the two positive electrode active material layers 742 provided on both surfaces of the positive electrode current collector foil 741 in the Y-axis direction. A negative electrode through hole 753a serving as the through hole 730 is provided in the negative electrode active material portion 753. The negative electrode through hole 753a is a circular through hole penetrating the negative electrode active material portion 753 in the Y-axis direction. That is, the negative electrode through hole 753a is a circular through hole penetrating, in the Y-axis direction, the negative electrode current collector foil 751 and the two negative electrode active material layers 752 provided on both surfaces of the negative electrode current collector foil 751 in the Y-axis direction.

The positive electrode through hole 743a and the negative electrode through hole 753a are located at positions at which at least portions thereof overlap when viewed in a penetrating direction of the through hole 730 (an alignment direction of the positive electrode through hole 743a and the negative electrode through hole 753a, i.e., the Y-axis direction). In the present example embodiment, when viewed in the Y-axis direction, the entire negative electrode through hole 753a overlaps the positive electrode through hole 743a. That is, when viewed in the Y-axis direction, the negative electrode through hole 753a has a smaller shape than that of the positive electrode through hole 743a, and is inward of the positive electrode through hole 743a.

The sizes of the positive electrode through hole 743a and the negative electrode through hole 753a are preferably as small as possible from the viewpoint of reducing or preventing a decrease in capacity of the energy storage device 10. However, if the sizes are too small, it becomes difficult to process the hole portions, or it becomes difficult to remove the electrode plates of the hole portions after the processing, and therefore, the sizes are preferably not too small. To be specific, the diameters of the positive electrode through hole 743a and the negative electrode through hole 753a (the through holes 730) are, for example, preferably about 0.8 mm or more (the opening areas are about 0.5 mm² or more), and more preferably about 1 mm or more (the opening areas are about 0.785 mm² or more). In the present example embodiment, the negative electrode through hole 753a is a circular through hole having a dimension (diameter, the same applies hereinafter) of about 0.8 mm to about 3 mm, and the positive electrode through hole 743a is a circular through hole having a dimension of about 1.5 mm to about 5 mm, for example. As described above, one or more through holes 730 include a through hole having an opening area of about 0.5 mm² or more, for example. In the present example embodiment, all of the positive electrode through holes 743a and the negative electrode through holes 753a (through holes 730) have opening areas of about 0.5 mm² or more (dimensions of about 0.8 mm or more), for example.

The positive electrode through hole 743a and the negative electrode through hole 753a can be formed by laser machining (laser welding or laser cutting), or the like, before the positive electrode plate 740 and the negative electrode plate 750 are wound. The positive electrode through hole 743a may be formed by forming (coating) the positive electrode active material layer 742 on the positive electrode current collector foil 741 in which a through hole is formed in advance, or the positive electrode through hole 743a may be formed by forming (coating) the positive electrode active material layer 742 on the positive electrode current collector foil 741 and then punching out the positive electrode current collector foil 741 and the positive electrode active material layer 742. The same applies to the negative electrode through hole 753a. The positive electrode through hole 743a and the negative electrode through hole 753a can be formed by press working, however, are preferably formed by laser machining in order to machine small holes at a high speed.

In the present example embodiment, the positive electrode plate 740 and the negative electrode plate 750 are wound such that the plurality of positive electrode active material portions 743 and the plurality of negative electrode active material portions 753 are stacked in the stacking direction. The plurality of positive electrode active material portions 743 and the plurality of negative electrode active material portions 753 are stacked in a direction orthogonal to the flat surface of the flat portion 712 (i.e., the Y-axis direction). In this case, a plurality of positive electrode through holes 743a and a plurality of negative electrode through holes 753a, which are continuously provided in that stacking direction, are provided in the plurality of positive electrode active material portions 743 and the plurality of negative electrode active material portions 753. That is, the plurality of positive electrode through holes 743a and the plurality of negative electrode through holes 753a, serving as the through holes 730, are provided in the positive electrode plate 740 and the negative electrode plate 750, respectively. The plurality of positive electrode through holes 743a and the plurality of negative electrode through holes 753a overlap when viewed from the penetrating direction of the through holes 730. In the present example embodiment, since the through hole 730 (the plurality of positive electrode through holes 743a and the plurality of negative electrode through holes 753a) is provided in the flat portion 712, the penetrating direction of the through hole 730 (the stacking direction of the plurality of positive electrode active material portions 743 and the plurality of negative electrode active material portions 753) can be defined to be the Y-axis direction.

The plurality of positive electrode through holes 743a are positioned such that the intervals therebetween increase from the positive electrode active material portion 743 to be positioned in the innermost layer (innermost circumference) of the electrode body 700 towards the positive electrode active material portion 743 to be positioned in the outermost layer (outermost circumference) of the electrode body 700, so as to be aligned with each other after the positive electrode plate 740 and the negative electrode plate 750 are wound. The same applies to the negative electrode through holes 753a.

The through hole 730 is also provided in an active material portion in an outermost layer (outermost circumference) among the plurality of positive electrode active material portions 743 and the plurality of negative electrode active material portions 753. When the negative electrode active material portion 753 is provided in the outermost layer (outermost circumference) of the electrode body 700, the negative electrode through hole 753a is also provided in the outermost negative electrode active material portion 753. Accordingly, in the electrode body 700, the plurality of positive electrode through holes 743a and the plurality of negative electrode through holes 753a continuously extend from the active material portion of the outermost layer (outermost circumference) to the active material portion of the innermost layer (innermost circumference) in the electrode body 700. That is, when viewed in the Y-axis direction, all the negative electrode through holes 753a provided in the plurality of negative electrode active material portions 753 are inward of all the positive electrode through holes 743a provided in the plurality of positive electrode active material portions 743.

A separator through hole 761a serving as the through hole 730 is provided in the separator 761. The separator through hole 761a is a circular through hole penetrating the separator 761 in the Y-axis direction. A separator through hole 762a serving as the through hole 730 is provided in the separator 762. The separator through hole 762a is a circular through hole penetrating the separator 762 in the Y-axis direction. In the present example embodiment, the separator through holes 761a and 762a are through holes having the same shape and the same size, however, may be through holes having different shapes or different sizes.

The separator through holes 761a and 762a are located at positions at which at least a portion of the separator through holes 761a and 762a overlaps the positive electrode through hole 743a and the negative electrode through hole 753a when viewed from the penetrating direction of the through hole 730 (the alignment direction of the positive electrode through hole 743a and the negative electrode through hole 753a, i.e., the Y-axis direction). In the present example embodiment, when viewed in the Y-axis direction, the separator through holes 761a and 762a are positioned such that all of the separator through holes 761a and 762a overlap the positive electrode through hole 743a and a portion of the separator through holes 761a and 762a overlap the negative electrode through hole 753a. That is, when viewed in the Y-axis direction, the separator through holes 761a and 762a have a shape less than that of the positive electrode through hole 743a and larger than that of the negative electrode through hole 753a, and are inward of the positive electrode through hole 743a, and the negative electrode through hole 753a is inward of the separator through holes 761a and 762a. The separator through holes 761a and 762a are circular through holes having diameters of about 1 mm to about 4 mm, for example.

The separator through holes 761a and 762a can be formed by laser machining, press working, or the like, before the positive electrode plate 740 and the negative electrode plate 750 are wound, similarly to the positive electrode through hole 743a and the negative electrode through hole 753a. The separator through holes 761a and 762a may be processed by irradiating the positions of the positive electrode through hole 743a and the negative electrode through hole 753a with a laser after the positive electrode plate 740 and the negative electrode plate 750 are wound. In this case, the separator through holes 761a and 762a may be through holes having the same size as that of the negative electrode through hole 753a or a size less than that of the negative electrode through hole 753a.

Accordingly, the plurality of separator through holes 761a and 762a are continuously provided in the separators 761 and 762, in the Y-axis direction, together with the plurality of positive electrode through holes 743a and the plurality of negative electrode through holes 753a. That is, the plurality of separator through holes 761a and 762a are continuously provided from the separator 761 or 762 positioned in the outermost layer (outermost circumference) to the separator 761 or 762 positioned in the innermost layer (innermost circumference) in the electrode body 700. Accordingly, in the electrode body 700, when viewed in the Y-axis direction, all the separator through holes 761a and 762a provided in the separators 761 and 762 are inward of all the positive electrode through holes 743a.

By providing the through hole 730 in the electrode body 700, the effective electrode area of the electrode body 700 decreases, and the capacity of the energy storage device 10 decreases (a capacity loss occurs). The effective electrode area of the electrode body 700 is an area of a region in which the active material layer is provided in the electrode plate (specifically, a region in which the positive electrode active material layer 742 is provided in the positive electrode plate 740). A ratio at which this effective electrode area decreases is referred to as an opening area ratio. The opening area ratio is a ratio of a total opening area of one or more through holes 730 positioned in a region in which the active material layer is provided in the electrode plate to an area of that region. To be specific, the opening area ratio is a ratio of a total of opening areas of the positive electrode through holes 743a positioned in a region in which the positive electrode active material layer 742 is provided in the positive electrode plate 740, to an area of that region. Specifically, the opening area ratio is a ratio of a total of opening areas of the positive electrode through holes 743a, which are positioned within a region in which the positive electrode active material layer 742 is provided, to an area of that region, when the positive electrode plate 740 is expanded by unwinding the wound state of the electrode body 700, and the positive electrode plate 740 is seen in a plan view.

The opening area ratio is, for example, preferably about 3% or less, more preferably less than about 0.1%, and still more preferably less than about 0.05%, from the viewpoint of reducing or preventing a decrease in capacity of the energy storage device 10. As described above, it can be said that the opening area ratio is a ratio of a capacity decrease amount (capacity loss) of the energy storage device 10 due to the through holes 730. Therefore, the ratio of the capacity decrease amount (capacity loss) of the energy storage device 10 is also, for example, preferably about 3% or less, more preferably less than about 0.1%, and still more preferably less than about 0.05%.

In the present example embodiment, the separator 762 is provided in an outermost layer (outermost circumference) of the electrode body 700, and the separator 762 is in contact with the porous body 800. The separator 762 does not necessarily have to be provided in the outermost layer (outermost circumference) of the electrode body 700. In this case, the negative electrode plate 750 (the outermost negative electrode active material portion 753) is provided in the outermost layer (outermost circumference) of the electrode body 700, and the negative electrode plate 750 (the negative electrode active material portion 753) is in contact with the porous body 800.

As described above, in the energy storage device 10 according to the present example embodiment of the present invention, a sheet-shaped structure (insulating sheet) having an insulating property is provided between the container 100 and the electrode body 700 in which the electrode plates (the positive electrode plate 740 and the negative electrode plate 750) and the separators 760 are stacked, and the through holes 730 are provided in the electrode plates. A porous body 800 is used as the insulating sheet, and the air permeability of the porous body 800 is lower than the air permeability of the separator 760. As described above, by providing the through hole 730 in the electrode plate of the electrode body 700, the through hole 730 can define and function as a path for an electrolyte solution, and therefore, the electrolyte solution easily permeates the electrode body 700. However, when an insulating sheet is provided between the electrode body 700 and the container 100, the insulating sheet may block the path for the electrolyte solution to the electrode body 700 during evacuation, liquid injection, or the like, when the electrolyte solution is injected into the container 100, which may make it difficult for the electrolyte solution to permeate the electrode body 700. Therefore, the porous body 800 is used as the insulating sheet, and the porous body 800 has lower air permeability (higher air permeability) than the separator 760. Accordingly, the electrolyte solution can pass through the porous body 800 relatively easily, and thus the electrolyte solution easily permeates the electrode body 700. As described above, in the energy storage device 10, since the electrolyte solution can permeate the electrode body 700 via the porous body 800 and the through holes 730 of the electrode plate, the electrolyte solution can easily permeate the electrode body 700 while insulating the electrode body 700 from the container 100.

When the permeation time of the electrolyte solution into the electrode body 700 is long, there is a concern that copper of the negative electrode plate 750 may be eluted and a short circuit may occur. However, since the electrolyte solution can easily permeate into the electrode body 700 to shorten the permeation time of the electrolyte solution into the electrode body 700, the occurrence of the short circuit can be reduced or prevented. Since an excess amount of the electrolyte solution can be stored in the holes of the porous body 800 and the through holes 730, a shortage of the electrolyte solution due to consumption of the electrolyte solution by reduction of the electrolyte solution (formation of an SEI film) during charge and discharge can be reduced or prevented. In particular, by positioning the porous body 800 in the vicinity of the bottom wall 113 of the container 100 or in contact with the bottom wall 113, an excess electrolyte solution accumulated in a lower portion of the container 100 can be accumulated in the holes of the porous body 800. When the gas is discharged from the gas discharge valve 140 to the outside of the energy storage device 10, the gas in the electrode body 700 can be easily discharged via the through holes 730 and the holes of the porous body 800. In particular, when the porous body 800 includes a material (polyolefin, or the like) which shrinks by heat, the porous body 800 shrinks by the heat (e.g., about 300° C. to about 600° C.) of the gas at the time of gas discharge, and the gas path can be expanded. By forming the through hole 730 in the flat portion 712 of the electrode body main-body portion 710 of the electrode body 700, the through hole 730 can be easily provided.

When the electrode body 700 having an elongated length in the winding axis direction is used, it is more difficult to impregnate the electrode body 700 with the electrolyte solution. Therefore, when such an elongated electrode body 700 is used, an effect obtained by adopting the configuration of an example embodiment of the present invention is high.

When the air permeability of the porous body 800 is set to be as low as about 250 sec/100 mL or less (i.e., the air permeability is set to be high), for example, the electrolyte solution can pass through the porous body 800 relatively easily. In general, the air permeability of the separator 760 is about 270 sec/100 mL to about 540 sec/100 mL, for example and therefore, by setting the air permeability of the porous body 800 to be as low as about 250 sec/100 mL or less, for example, the electrolyte solution can pass through the porous body 800 relatively easily.

When the porous body 800 is provided between the container 100 and the through hole 730 of the electrode body 700, the porous body 800 may be brought into close contact with the through hole 730 due to deformation of the container 100, or the like, during evacuation at the time of injection of an electrolyte solution into the container 100. Even in this case, by making the air permeability of the porous body 800 low, the electrolyte solution can pass through the porous body 800, and therefore, the path for the electrolyte solution to the electrode body 700 can be restrained from being blocked. In particular, when the energy storage device 10 is a pouch-type energy storage device and the container 100 is made of a laminated film, the container 100 is likely to be deformed and the porous body 800 is likely to be brought into close contact with the through hole 730, and therefore, an effect obtained by adopting the configuration of an example embodiment of the present invention is high.

A plurality of positive electrode through holes 743a and a plurality of negative electrode through holes 753a are provided in the positive electrode plate 740 and the negative electrode plate 750, and the plurality of positive electrode through holes 743a and the plurality of negative electrode through holes 753a overlap when viewed from a penetrating direction of the through holes 730.

Accordingly, since the plurality of positive electrode through holes 743a and the plurality of negative electrode through holes 753a can define and function as paths for the electrolyte solution, the electrolyte solution more easily permeates the electrode body 700.

In the energy storage device 10, the electrode body 700 has a wound configuration, and the liquid injector 130 for an electrolyte solution is provided in a wall (long side wall 111) of the container 100, which extends in the winding axis direction of the electrode body 700, and therefore, the energy storage device 10 has a configuration in which an electrolyte solution hardly permeates from the outside to the inside of the electrode body 700 when the electrolyte solution is injected into the container 100. As described above, the energy storage device 10 has a structure in which the electrolyte solution hardly permeates the electrode body 700, and therefore, an advantageous effect obtained by adopting the configuration of an example embodiment of the present invention is high. In particular, since the liquid injector 130 (liquid injection port 131) is provided in the long side wall 111 of the container 100, the porous body 800 may be brought into close contact with the liquid injection port 131 of the long side wall 111 when evacuation is performed from the liquid injection port 131 at the time of injection of the electrolyte solution into the container 100. Even in this case, by making the air permeability of the porous body 800 low, the electrolyte solution can pass through the porous body 800, and therefore, the path for the electrolyte solution to the electrode body 700 can be restrained from being blocked.

When the porous body 800 includes a nonwoven fabric, the porous body 800 which is thin, has high strength, and is inexpensive can be produced. Since the nonwoven fabric can simply be provided between the electrode body 700 and the container 100, the porous body 800 can be easily provided. In particular, since the porous body 800 can be provided by a simple operation of winding the nonwoven fabric around the electrode body 700, the porous body 800 can be easily located between the electrode body 700 and the container 100.

Since the porous body 800 is configured to cover the entire electrode body 700, the above-described effect can be achieved over the entire electrode body 700.

Energy storage devices 10 according to example embodiments of the present invention have been described above. However, the present invention is not limited to the above-described example embodiments. The example embodiments disclosed herein are illustrative in all aspects, and the scope of the present invention includes all modifications within the meaning and scope of equivalence of the scope of the claims.

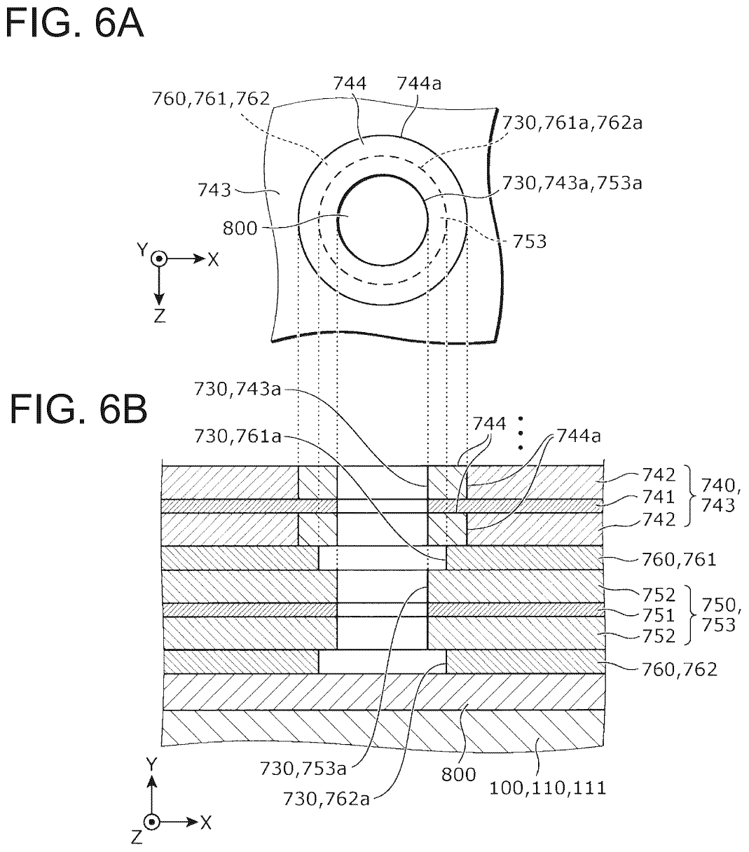

In the above-described example embodiment, a resin may be applied to or impregnate the positive electrode active material layer 742 around the positive electrode through hole 743a of the through hole 730 of the electrode body 700. FIGS. 6A and 6B are a front view and a sectional view illustrating a configuration of a through hole 730 of an electrode body 700 according to a modification example 1 of the present example embodiment. FIGS. 6A and 6B are views corresponding to FIGS. 5A and 5B.

As illustrated in FIGS. 6A and 6B, in the present modification example, the positive electrode through hole 743a preferably has the same size as that of the negative electrode through hole 753a when viewed in the Y-axis direction, and an insulating portion 744 is provided in the positive electrode active material layer 742 around the positive electrode through hole 743a. That is, the positive electrode plate 740 includes the insulating portion 744 which is positioned around the positive electrode through hole 743a and whose size of the outer circumference 744a is larger than that of the negative electrode through hole 753a. Other configurations of the present modification example are the same as those of the above-described example embodiment, and thus detailed description thereof will be omitted.

The insulating portion 744 is a portion masked by dissolving an insulator such as resin into the positive electrode active material layer 742 around the positive electrode through hole 743a. That is, the insulating portion 744 is a portion in which the content of an insulating material such as resin is larger than that in other portions of the positive electrode active material layer 742. The insulating portion 744 can be formed by dissolving a UV-curable epoxy resin, which is cured by irradiation with ultraviolet rays, in the positive electrode active material layer 742, or dissolving a polyolefin resin, such as PE or PP, which is melted by heating, in the positive electrode active material layer 742. The insulating portion 744 can be easily formed by pressing a resin molding die and pouring resin into the resin molding die. The insulating portion 744 may be formed by positioning a bindable modified polyolefin sheet (a sheet obtained by introducing polar groups into polyolefin to impart adhesiveness to a different material), which has been molded into a shape to cover the periphery of the positive electrode through hole 743a in advance, on the positive electrode active material layer 742 around the positive electrode through hole 743a, and heating and melting the bindable modified polyolefin sheet thus causing impregnation. When the insulating material such as the resin permeates the positive electrode active material layer 742, the positive electrode active material layer 742 is deactivated (the discharge capacity is reduced).

As described above, the energy storage device 10 according to the present modification example can achieve the same effects as those of the above-described example embodiments. In particular, when the positive electrode through hole 743a and the negative electrode through hole 753a are provided in the positive electrode plate 740 and the negative electrode plate 750, it is preferable to adopt a configuration in which the negative electrode active material layer 752 covers the positive electrode active material layer 742, regardless of the sizes of the positive electrode through hole 743a and the negative electrode through hole 753a. Therefore, the insulating portion 744 whose outer circumference 744a is larger in size than the negative electrode through hole 753a is positioned around the positive electrode through hole 743a in the positive electrode plate 740. Accordingly, even in a case where the positive electrode through hole 743a is of the same size as the negative electrode through hole 753a or less than the negative electrode through hole 753a (the same size in the present modification example), the positive electrode active material layer 742 can be covered with the negative electrode active material layer 752. That is, by deactivating the positive electrode active material layer 742 around the positive electrode through hole 743a, the active positive electrode active material layer 742 can be covered with the negative electrode active material layer 752, and lithium electrodeposition on the negative electrode plate 750 can be reduced or prevented.

In the present modification example, the positive electrode through hole 743a may be smaller or larger than the negative electrode through hole 753a when viewed in the Y-axis direction as long as the size of the outer circumference 744a of the insulating portion 744 is larger than that of the negative electrode through hole 753a. The separator through holes 761a and 762a may be the same in size as the negative electrode through hole 753a and the positive electrode through hole 743a, or may be smaller in size than the negative electrode through hole 753a and the positive electrode through hole 743a.

In the above-described example embodiments, the porous body 800 is configured to cover both sides of the electrode body 700 and the current collector 600 in the X-axis direction, and both sides thereof in the Y-axis direction, and the Z-axis negative direction thereof. However, the alignment position and size of the porous body 800 are not particularly limited. The porous body 800 may cover the electrode body 700 and the current collector 600 in the Z-axis positive direction. The porous body 800 may be an insulating sheet having a U-shape when viewed in the X-axis direction, which covers both sides of the electrode body 700 and the current collector 600 in the Y-axis direction and the Z-axis negative direction, without covering both sides of the electrode body 700 and the current collector 600 in the X-axis direction. The porous body 800 may cover only a portion of the electrode body 700 and the current collector 600 in the Y-axis direction, or may cover only a portion thereof in the Z-axis negative direction. The porous body 800 may cover only one side of the electrode body 700 and the current collector 600 in the Y-axis direction. As described above, the porous body 800 does not necessarily have to cover any portion of both sides of the electrode body 700 and the current collector 600 in the X-axis direction, both sides thereof in the Y-axis direction, and the Z-axis negative direction thereof. That is, it is sufficient that the porous body 800 is located between the electrode body 700 and the container 100, and the porous body 800 does not necessarily have to be located between the liquid injector 130 and the through hole 730, does not necessarily have to be located between the container 100 and the through hole 730, or does not necessarily have to be located between the liquid injector 130 and the electrode body 700.

In the above-described example embodiment, the porous body 800 has air permeability of about 250 sec/100 mL or less, for example. However, as long as the air permeability of the porous body 800 is lower than that of the separators 760 included in the electrode body 700, the air permeability of the porous body 800 may be higher than about 250 sec/100 mL, for example. The porous body 800 does not have to be made of the above-described material including a nonwoven fabric, and may be made of any material as long as the material has lower air permeability than the separator 760.

In the above-described example embodiment, it is assumed that the liquid injector 130 is located at an end in the Z-axis positive direction and a central portion in the X-axis direction of the long side wall 111 in the Y-axis negative direction of the container main-body 110 of the container 100. However, the alignment position of the liquid injector 130 is not limited. The liquid injector 130 may be located at an end of the long side wall 111 in the X-axis direction, or may be located at a central portion of the long side wall 111 in the Z-axis direction or at an end of the long side wall 111 in the Z-axis negative direction. The liquid injector 130 may be located in the long side wall 111 in the Y-axis positive direction. The liquid injector 130 may be located in the lid 120 of the container 100, or may be located in the bottom wall 113 of the container main-body 110. That is, the liquid injector 130 may be located in a wall extending in the winding axis direction of the electrode body 700. Alternatively, the liquid injector 130 may be located in the short side wall 112 of the container main-body 110. The gas discharge valve 140 is assumed to be located in the lid 120, however, may be located in any wall of the container main-body 110.

In the above-described example embodiments, the through hole 730 of the electrode body 700 is located at an end in the Z-axis positive direction of the flat portion 712 in the Y-axis negative direction of the electrode body main-body portion 710, however, may be located at any position of the electrode body 700. The through hole 730 may be provided in a central portion of the flat portion 712 in the Z-axis direction or an end of the flat portion 712 in the Z-axis negative direction. The through hole 730 may be provided in the flat portion 712 of the electrode body main-body portion 710 in the Y-axis positive direction, or may be provided in the curved portion 711 of the electrode body main-body portion 710. When the through hole 730 is provided in the curved portion 711, the through hole 730 is less likely to be closed by the container 100, and thus the electrolyte solution is likely to easily permeate the electrode body 700. When the through hole 730 is provided in a lower portion (an end in the Z-axis negative direction) of the electrode body 700, the through hole 730 can be located at a position close to the bottom wall 113 of the container 100, and therefore, the electrolyte solution accumulated in the lower portion of the container 100 easily permeates the electrode body 700. In particular, even when the amount of the electrolyte solution in the container 100 is small (e.g., at the end of life), the electrolyte solution accumulated in the lower portion of the container 100 can be caused to permeate the electrode body 700. By providing the through hole 730 in the lower portion of the electrode body 700, an excess electrolyte solution accumulated in the lower portion of the container 100 can also be stored in the through hole 730.

In the above-described example embodiments, it is assumed that six through holes 730 are provided in the electrode body 700, for example. However, the number of through holes 730 is not particularly limited, and may be a plurality other than six, or may be one. The alignment position of the through hole 730 is also not particularly limited, and the plurality of through holes 730 may be aligned in a direction intersecting with the X-axis direction, or the plurality of through holes 730 may be randomly positioned. When the length of the electrode body 700 in the X-axis direction is further increased, it is preferable to provide further through hole (s) 730 at different position(s) in the X-axis direction of the electrode body 700. When the length of the electrode body 700 in the Z-axis direction is increased, it is preferable to provide further through hole(s) 730 at different position(s) in the Z-axis direction of the electrode body 700. Accordingly, the electrolyte solution can easily permeate the electrode body 700.

In the above-described example embodiments, it is assumed that the through holes 730 (the positive electrode through hole 743a and the negative electrode through hole 753a) are provided in all of the plurality of positive electrode active material portions 743 and the plurality of negative electrode active material portions 753 that are stacked. However, the present invention is not limited thereto. The through hole 730 does not necessarily have to be provided in any of the positive electrode active material portions 743 or any of the negative electrode active material portions 753. Similarly, regarding the separators 761 and 762, there may be a portion where the through holes 730 (the separator through holes 761a and 762a) are not provided, between the separators 761 and 762 in the outermost layers and the separators 761 and 762 in the innermost layers in the electrode body 700.

In the above-described example embodiments, it is assumed that the through holes 730 (the positive electrode through hole 743a and the negative electrode through hole 753a) are provided in both the positive electrode active material portion 743 and the negative electrode active material portion 753, however, the present invention is not limited thereto. The through hole 730 may be provided in only one of the positive electrode active material portion 743 and the negative electrode active material portion 753. Similarly, regarding the separators 761 and 762, the through holes 730 (the separator through holes 761a and 762a) may be provided in only one of the separators 761 and 762, or the through holes 730 do not necessarily have to be provided in both of the separators 761 and 762.

In the above-described example embodiments, the negative electrode through hole 753a has a smaller shape than that of the positive electrode through hole 743a when viewed in the Y-axis direction, and is inward of the positive electrode through hole 743a. However, the present invention is not limited thereto. The negative electrode through hole 753a may be located at a position slightly shifted from the positive electrode through hole 743a without being inward of the positive electrode through hole 743a, or may be located at a position not overlapping the positive electrode through hole 743a, and the shapes, the size relationship, and the alignment positions of the positive electrode through hole 743a and the negative electrode through hole 753a are not particularly limited. However, even in this case, it is preferable that a portion which is not opposed to the negative electrode active material layer 752 does not exist in the positive electrode active material layer 742 (i.e., active positive electrode active material layer 742). That is, it is preferable that the entire positive electrode active material layer 742 (i.e., active positive electrode active material layer 742) is opposed to the negative electrode active material layer 752. Similarly, the separator through holes 761a and 762a may be located at positions slightly shifted from the positive electrode through hole 743a and the negative electrode through hole 753a, or may be located at positions not overlapping the positive electrode through hole 743a and the negative electrode through hole 753a. That is, the shape, size relationship, and alignment position of the separator through holes 761a and 762a, and the positive electrode through hole 743a and the negative electrode through hole 753a are not particularly limited. However, even in this case, it is preferable that the entire positive electrode active material layer 742 (i.e., active positive electrode active material layer 742) is opposed to the separators 761 and 762.

In the above-described example embodiments, an inorganic coating layer may be provided on the separator 760 (the separators 761 and 762). The inorganic coating layer is a coating layer to be coated on the separator. Specifically, the inorganic coating layer is a coating layer including inorganic particle and a binder (binding material), and an entire surface or a portion of the surface of the separator 760, or entire surfaces or a portion of the surfaces of the separator 760 may be coated with the inorganic coating layer via the binder. As the binder, a known material can be appropriately used. The inorganic coating layer preferably contains, as inorganic particle, at least one of aluminum silicate, barium sulfate, or alumina (boehmite), and particularly preferably contains at least one of barium sulfate or alumina. In the inorganic coating layer, a permeation area of the electrolyte solution at a 300-second mark after the electrolyte solution has been dropped is preferably about 80 mm² or more, and more preferably about 90 mm² or more, for example. A method for measuring the permeation area is as follows. The evaluation sample is placed on a glass plate such that the front side is the coating layer and the rear side is the separator 760, and an electrolyte solution of about 0.3 cc is dropped to the center of the sample. The time when the electrolyte solution adheres to the organic or inorganic coating layer is defined as 0 second, and a portion discolored by the permeation of the liquid at the 300-second mark is regarded as a permeation range. When the electrolyte solution dropped on the inorganic coating layer spreads in a circular shape, the diameter of the permeation range is measured at three positions, and the area of the circle calculated from the average value of the diameters is defined as the permeation area. When it is visually confirmed that the shape of the spread electrolyte solution is a distorted shape which is not a circular shape, such as an elliptical shape, a portion discolored by permeation of the liquid is regarded as a permeation range, and image processing is performed to calculate a permeation area. Propylene carbonate (PC) is used as the electrolyte solution.

Since the larger the particle diameter of the inorganic particle is, the higher the permeation rate becomes, the average primary particle diameter of the inorganic substance (inorganic particle) is preferably about 1 μm or more, and more preferably about 3 μm or more, for example. The particle diameter of the inorganic substance (inorganic particle) is equal to or less than the thickness of the inorganic coating layer 760b. The inorganic coating layer may be thicker than the separators 760 (separators 761 and 762). However, when the inorganic coating layer covers one surface of the separator 760 (separator 761 or 762), and if the inorganic coating layer is thinner than the separator substrate, it is preferable in that the thickness of the separator 760 can be reduced.

When the inorganic coating layer is provided on the separator 760 (the separators 761 and 762) and the through hole 730 is provided in the electrode body 700, the electrolyte solution can permeate the electrode body 700 from the separator 760 whose permeability of the electrolyte solution is improved by the inorganic coating layer and via the through hole 730, and thus the electrolyte solution permeates the electrode body 700 in a shorter time. Therefore, it is more preferable that the through hole 730 is provided in the electrode body 700.

As the length of the electrode body 700 (the length from one end edge to the other end edge of the electrode body 700 in the winding axis direction (X-axis direction)) is larger, it is more difficult to cause the electrolyte solution to permeate the electrode body 700, and therefore, the advantageous effect obtained by forming the inorganic coating layer on the separator 760 can be achieved. Therefore, the length of the electrode body 700 is about 500 mm or more, preferably larger than about 500 mm, more preferably about 550 mm or more, and still more preferably about 600 mm or more, for example. The length of the electrode body main-body portion 710 may be about 500 mm or more, preferably longer than about 500 mm, more preferably about 550 mm or more, and still more preferably about 600 mm or more, for example.

From the viewpoint of effectively performing permeation of the electrolyte solution, when the through hole 730 is not provided in the electrode body 700, the length of the electrode body 700 (or the length of the electrode body main-body portion 710) described above is preferably about 800 mm or less, and more preferably about 700 mm or less, for example. When the through hole 730 is provided in the electrode body 700, the length of the electrode body 700 (or the length of the electrode body main-body portion 710) is preferably equal to or less than about 1600 mm, and more preferably equal to or less than about 1400 mm, for example. That is, when the through hole 730 is not provided in the electrode body 700, the length of the electrode body 700 (or the length of the electrode body main-body portion 710) is preferably about 500 mm or more and about 800 mm or less, more preferably more than about 500 mm and about 800 mm or less, still more preferably about 550 mm or more and about 700 mm or less, and particularly preferably about 600 mm or more and about 700 mm or less, for example. When the through hole 730 is provided in the electrode body 700, the length of the electrode body 700 (or the length of the electrode body main-body portion 710) is preferably about 500 mm or more and about 1600 mm or less, more preferably longer than about 500 mm and about 1600 mm or less, still more preferably about 550 mm or more and about 1400 mm or less, and particularly preferably about 600 mm or more and about 1400 mm or less, for example.

As described above, by coating the separator 760 with the inorganic coating layer, the permeability (wettability and capillary force) of the electrolyte solution for the separator 760 can be improved. Therefore, since the time taken for the electrolyte solution to permeate the electrode body 700 can be shortened, the electrolyte solution can easily permeate the electrode body 700. When the penetration time of the electrolyte solution into the electrode body 700 is long, there is a concern that copper of the negative electrode plate 750 may be eluted and a short circuit may occur. However, since the penetration time of the electrolyte solution into the electrode body 700 can be shortened, the occurrence of the short circuit can be reduced or prevented. Specifically, when it takes six hours or more for the electrolyte solution to permeate the electrode body 700, there is a concern that copper of the negative electrode plate 750 may be eluted and a short circuit may occur. However, by coating the separator 760 with the inorganic coating layer, the occurrence of a short circuit can be reduced or prevented.

In the above-described example embodiments, both of the pair of terminals 300 protrude from the container 100 in the Z-axis positive direction. However, the protruding direction of the terminals 300 is not particularly limited. The pair of terminals 300 may protrude from the container 100 to either one side in the X-axis direction, or may protrude to both sides in the X-axis direction.

In the above-described example embodiments, the electrode body 700 has an elongated cylindrical shape (flat shape) including the curved portion 711 and the flat portion 712, however, may have a cylindrical shape, an elliptical cylindrical shape, or the like. In the electrode body 700, the end 720 may be a tab portion (a portion in which a plurality of tabs of an electrode plate are stacked) protruding from a portion of the electrode body main-body portion 710. In the above-described example embodiments, the electrode body 700 is a wound electrode body in which the winding axis L is parallel to the lid 120, however, may be a wound electrode body in which the winding axis L is perpendicular to the lid 120. The electrode body 700 may be a laminated (stacked) electrode body formed by stacking a plurality of flat plate-shaped electrode plates and separators, or a bellows-type electrode body formed by folding an electrode plate into a shape of a bellows, or the like. The electrode body 700 does not necessarily have a shape that is long in the X-axis direction.

Configurations constructed by arbitrarily combining elements, portions, structures, features, characteristics, etc., included in the above-described example embodiments and the modification examples thereof are also included in the scope of the present invention.

Example embodiments of the present invention can be applied to energy storage devices, such as lithium-ion secondary batteries.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage device comprising:
an electrode body in which an electrode plate and a separator are stacked;
an electrolyte solution;
a container to accommodate the electrode body and the electrolyte solution; and
a sheet-shaped porous body provided with an insulating property and between the electrode body and the container; wherein
a through hole is provided in the electrode plate; and
the porous body has lower air permeability than the separator.

2. The energy storage device according to claim 1, wherein the porous body has an air permeability of about 250 sec/100 mL or less.

3. The energy storage device according to claim 1, wherein the porous body is located between the container and the through hole.

4. The energy storage device according to claim 1, wherein
the electrode plate includes a positive electrode plate and a negative electrode plate;
the through hole includes a plurality of positive electrode through holes and a plurality of negative electrode through holes respectively provided in the positive electrode plate and the negative electrode plate; and
the plurality of positive electrode through holes and the plurality of negative electrode through holes overlap each other when viewed from a penetrating direction of the through holes.

5. The energy storage device according to claim 1, wherein
the electrode plate has a wound configuration; and
the container includes a liquid injector for the electrolyte solution in a wall extending in a winding axis direction of the electrode body.

6. The energy storage device according to claim 1, wherein the porous body includes a nonwoven fabric.

7. The energy storage device according to claim 1, wherein
the electrode plate has a wound configuration; and
the separator includes an inorganic coating layer including an inorganic particle.

8. The energy storage device according to claim 7, wherein a length of the electrode body in a winding axis direction is about 500 mm or more.

9. The energy storage device according to claim 7, wherein a permeation area of the electrolyte solution in the inorganic coating layer at a 300-second mark after the electrolyte solution has been dropped is about 80 mm² or more.

10. The energy storage device according to claim 7, wherein the inorganic coating layer includes at least one of barium sulfate or alumina as the inorganic particle.

11. An energy storage device comprising:
an electrode body in which an electrode plate and a separator are stacked;
an electrolyte solution;
a container to accommodate the electrode body and the electrolyte solution; and
a sheet-shaped porous body provided with an insulating property and between the electrode body and the container; wherein
a through hole is provided in the electrode plate; and
the separator and the porous body are different structural elements.

12. The energy storage device according to claim 11, wherein the porous body has lower air permeability than the separator.

13. The energy storage device according to claim 11, wherein the porous body has an air permeability of about 250 sec/100 mL or less.

14. The energy storage device according to claim 11, wherein the porous body is located between the container and the through hole.

15. The energy storage device according to claim 11, wherein
the electrode plate includes a positive electrode plate and a negative electrode plate;
the through hole includes a plurality of positive electrode through holes and a plurality of negative electrode through holes respectively provided in the positive electrode plate and the negative electrode plate; and
the plurality of positive electrode through holes and the plurality of negative electrode through holes overlap each other when viewed from a penetrating direction of the through holes.

16. An energy storage device comprising:
an electrode body in which an electrode plate and a separator are stacked;
an electrolyte solution;
a container to accommodate the electrode body and the electrolyte solution; and
a sheet-shaped porous body provided with an insulating property and between the electrode body and the container; wherein
a through hole is provided in the electrode plate; and
the electrode body has an elongated shape.

17. The energy storage device according to claim 16, wherein the porous body has lower air permeability than the separator.

18. The energy storage device according to claim 16, wherein the porous body has an air permeability of about 250 sec/100 mL or less.

19. The energy storage device according to claim 16, wherein the porous body is located between the container and the through hole.

20. The energy storage device according to claim 16, wherein
the electrode plate includes a positive electrode plate and a negative electrode plate;
the through hole includes a plurality of positive electrode through holes and a plurality of negative electrode through holes respectively provided in the positive electrode plate and the negative electrode plate; and
the plurality of positive electrode through holes and the plurality of negative electrode through holes overlap each other when viewed from a penetrating direction of the through holes.
